(19) United States
(12) Patent Application Publication
(10) Pub. No.: US 2024/0337087 A1
(43) Pub. Date: Oct. 10, 2024

(54) APPARATUS, METHODS, AND SYSTEMS FOR PRESERVING AND TRANSFERRING LAND FROM A FIRST LOCATION TO A SECOND LOCATION

(71) Applicant: Thornton Equipment Services, Inc., New Lenox, IL (US)

(72) Inventor: Jason Verbeek, New Lenox, IL (US)

(21) Appl. No.: 18/132,416

(22) Filed: Apr. 9, 2023

(51) Int. Cl. E02F 1/00; E02F 3/18; E02F 3/20; E02F 3/65

(52) U.S. Cl. CPC E02F 1/00; E02F 3/188; E02F 3/205; E02F 3/654

(57) ABSTRACT

A method for transferring endangered land from a first location in a first arrangement to a second location in the same first arrangement is disclosed. The method includes cutting, with a first cutting tool, a first pair of parallel rows in a first section of land of a first location. Then cutting a second pair of parallel rows, in the first section, that are perpendicular to the first pair of parallel rows creating an intersection of land between the first and second rows defining a transferable parcel and cutting a bottom side of the transferable parcel of land. The next step in the method is to lift the transferable parcel from a ground, placing the transferable parcel onto a portable bed, transferring the portable bed to the second location, and transplanting the transferable parcel into a receiving section of land of the second location in the same first arrangement.

### CROSS-REFERENCE TO RELATED APPLICATIONS

Not applicable.

### STATEMENT REGARDING FEDERALLY SPONSORED RESEARCH OR DEVELOPMENT

Not applicable.

### INCORPORATION BY REFERENCE OF MATERIAL SUBMITTED ON A COMPACT DISC

Not applicable.

### TECHNICAL FIELD

The present disclosure relates to the field of earthwork, and more specifically to the field of transplanting pieces or sections of land from one location to another.

### BACKGROUND

Here are the problems with the existing technology. The movement of land is a complex and dynamic process that can occur naturally or be induced by human activities. Natural land movement, such as earthquakes, landslides, and erosion, can have devastating effects on communities and infrastructure. In contrast, human induced land movements, such as mining, construction, and landfills, can also have significant impacts on the environment and the surrounding communities. Methods for moving land have been developed over time to mitigate the negative impacts of natural and human induced land movements. As known from the prior art, modern techniques for moving land have been developed as technology has advanced. For example, earthmoving equipment, such as bulldozers and excavators, are commonly used for construction and mining projects to move large amounts of earth quickly and efficiently.

A common method for moving land is known as transplanting earthwork. Transplanting earthwork is a practice that involves moving soil or earth from one location to another. It has been used by various cultures throughout history for a variety of purposes such as constructing buildings, creating farmland, and building infrastructure including roads and canals. Transplanting earthwork continues to be an important part of modern construction and engineering projects. Methods for transplanting earthwork include excavation and hauling, hydraulic filling, cutting and filling, pushing and scraping, terracing, etc. Each of these methods have advantages and disadvantages depending on factors such as the amount of soil to be moved, the distance between the source and destination sites, the terrain of the land being transplanted, etc. Present methods of excavation and cutting of land contain a number of challenges including operating in difficult soil conditions. For example, soil that is hard or rocky may require heavy equipment or specialized tools to dig through.

The prior art presents methods for transporting grass turf and sod; however the prior art lacks an efficient method for preparing land for transplant, cutting into the land, moving that portion of land, and replanting the piece of land at a second location. Common issues with transplanting the top layer of land such as sod, include damage to the grass, uneven cutting, drainage issues, incomplete removal leaving roots or grass that can hinder the growth of the transplanted land, etc. As a result, there exists a need for improvements over the prior art and more particularly for a more efficient apparatus, method, and system for preserving and transporting land from a first location to a second location.

### SUMMARY

An apparatus, method, and system for preserving and transporting land from a first location to a second location is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a method for transferring land from a first location in a first arrangement to a second location in the same first arrangement. The method includes cutting, with a first cutting tool, a first pair of parallel rows in the first section of land of a first location. Then cutting a second pair of parallel rows, in the first section, that are perpendicular to the first pair of parallel rows creating an intersection of land between the first and second rows defining a transferable parcel. Next, the method includes cutting the bottom side of the transferable parcel of land using a second cutting tool. Once all cuts are done, the next step in the method is to lift the transferable parcel from a ground at the first location, placing the transferable parcel onto a portable bed, transferring the portable bed to the second location, and transplanting the transferable parcel into a receiving section of land of the second location in the same first arrangement. The tools used to cut sections of land contain a cutting edge configured to cut through soil and roots without damaging the transferable parcel. The portable bed receiving the transferable parcel of land includes a partially open top section for allowing the transferable land to be exposed to the atmosphere, and a bottom platform being openable such that the bottom platform consist of an open configuration and a closed configuration.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the disclosure and together with the description, explain the principles of the disclosed embodiments. The embodiments illustrated herein are presently preferred, it being understood, however, that the disclosure is not limited to the precise arrangements and instrumentalities shown, wherein:

FIG. 1 is a flowchart illustrating a method for transferring land from a first location in a first arrangement to a second location in the first arrangement, according to an example embodiment;

FIG. 2 is a perspective side view of a first cutting tool having an axel, a first blade, and a second blade, according to an example embodiment;

FIG. 3 is a perspective of a first cutting tool making a first pair of parallel rows in an area of land, according to an example embodiment;

FIG. 4 is a perspective view of a first cutting tool digging an elongated trench adjacent to the first pair of parallel rows, according to an example embodiment;

FIG. 5 is a perspective view of a first cutting tool cutting a second pair of parallel rows that are perpendicular to the first pair of parallel rows, according to an example embodiment;

FIG. 6 is a perspective view of a second cutting tool cutting a bottom side of an intersection of land, according to an example embodiment;

FIG. 7 is a perspective view of the second cutting tool, according to an example embodiment;

FIG. 8 is a flowchart illustrating a method for transplanting a transferable parcel of land at a second location, according to an example embodiment;

FIG. 9 is an isometric view of a transferable parcel, according to an example embodiment;

FIG. 10 is an isometric view of a portable bed having a top section and a bottom platform, according to an example embodiment;

FIG. 11 is a perspective view of the second cutting tool lifting the transferable parcel from the ground, according to an example embodiment;

FIG. 12 is a perspective view of a second cutting tool placing the transferable parcel onto a portable bed, according to an example embodiment;

FIG. 13 is a perspective view of several portable beds being transported, according to an example embodiment;

FIG. 14 is a perspective view of a portable bed being disposed near a receiving section of land, according to an example embodiment;

FIG. 15 is a perspective view of a second cutting tool removing a transferable parcel from a portable bed, according to an example embodiment;

FIG. 16 is a perspective view of a second cutting tool placing the transferable parcel in the receiving section, according to an example embodiment;

FIG. 17 is a flowchart illustrating a method for transferring land from a first location in a first arrangement to a second location in the first arrangement, according to a second example embodiment;

FIG. 18 is a flowchart illustrating a method of maintaining a transferable parcel to promote healthy growth and to preserve the transferable parcel, according to an example embodiment; and

FIG. 19 is a front perspective view of healthy growth of a transferable parcel, according to an example embodiment.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions, or modifications may be made to the elements illustrated in the drawings, and the methods described herein may be modified by substituting reordering or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the problems with the prior art by providing an apparatus, method, and system for preserving and transferring land from a first location in a first arrangement to a second location in the first arrangement. This method improves upon the prior art by ensuring the safe transplant of the parcel and the maintenance necessary to promote healthy growth and preserve the transferable parcel. In addition to the maintenance performed, prior to transplant, the method includes examining the transferable parcel for invasive species and endangered species. If invasive species are discovered, then the method includes removing the invasive species from the transferable parcel before transporting the transferable parcel to the second location, and if endangered species are discovered, then further preserving the endangered species.

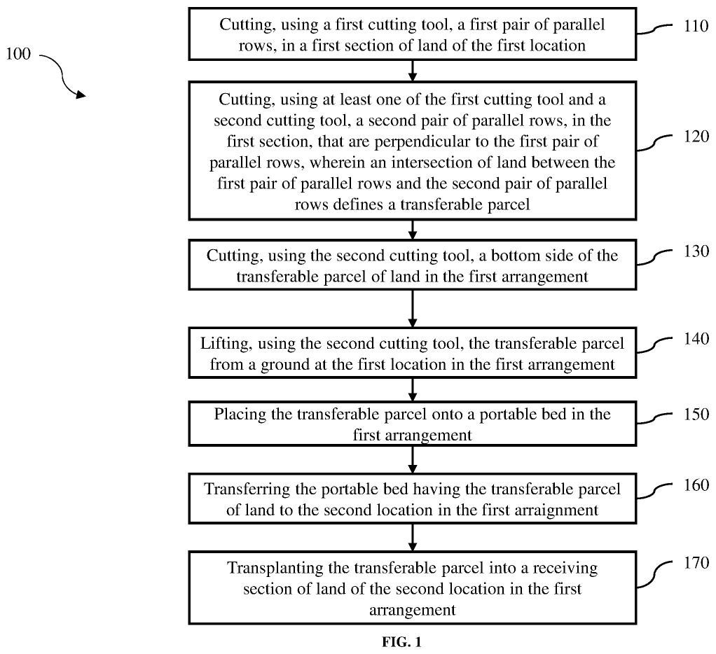

FIG. 1 is a flowchart depicting a method 100 for transferring land from a first location 330 in a first arrangement 340 to a second location 1410 remote from the first location in the first arrangement 340, according to an example embodiment. Generally, land may be defined as the physical and tangible resource that covers the earth's surface. More specifically land may be defined as soil having a composition such that organic matter, living organisms, water, nutrients, and minerals may be contained within. Land is present in a variety of ecosystems including marshes or wetland, forests, deserts, mountains, urban land, agricultural land, etc. Land is a vital resource providing a wide range of benefits to human society and the natural world including providing habitats for plant and animal species, supporting food and agriculture production, providing natural resources such as timber, minerals, and fossil fuels, regulating the climate by absorbing carbon dioxide from the atmosphere and storing it in plant and soil biomass. The importance of land is so great that we must preserve and maintain it to the best of our ability.

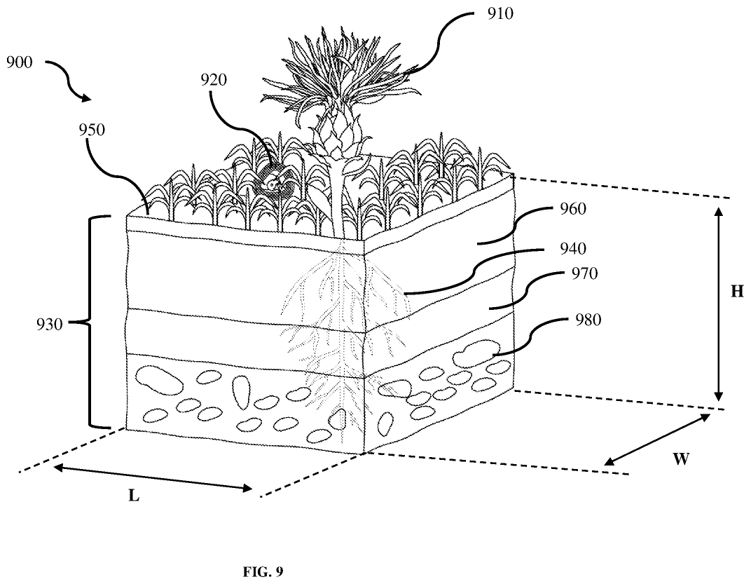

The first location 330 may generally defined as any geographical region on earth's surface or elsewhere. More specifically, the first location may be defined as a particular place where a section of land is needed or wanted to be transplanted and maintained elsewhere while remaining in the same arrangement. A first arrangement 340 (for example as illustrated in FIG. 9) may be defined as any position, orientation, composition, configuration, order, presentation, or quality of a piece of land. For example, the first arrangement may be such that animals, plant life, and organisms that exist or live in the section of land are not significantly disturbed. The first arrangement may include the order of which the parcels are removed such that any organisms living within the parcels are transplanted together at a second location, in the same first arrangement. The first arrangement may include certain microorganisms living in the soil or certain species found in a parcel of land. The first arrangement may include organisms living twenty inches deep in the ground. The first arrangement may include several layers of soil at depths of twenty-four inches. As shown and described in FIG. 9, the transferable parcel of land in the first arrangement may vary in depth from eight inches to twenty-four inches. Because of the specific arrangement of the land, when transferring, the operator may utilize a planar surface to place the parcel on such that the first arrangement remains horizontal maintaining the arrangement from the first location. The importance of keeping the parcel in its same first arrangement, for example horizontally, lies in the structure of the parcel preventing the parcel from being bent or disturbed while in transit. Bending or rolling the land in the first arrangement from the first location may destroy or break certain plant species or habitats present inside the parcel. A second location 1410 remote from the first location may generally be defined as any geographical region on earth's surface or elsewhere, and more specifically may be defined as a particular place where a section of land is needed or wanted to be transplanted to. The method begins with step 110.

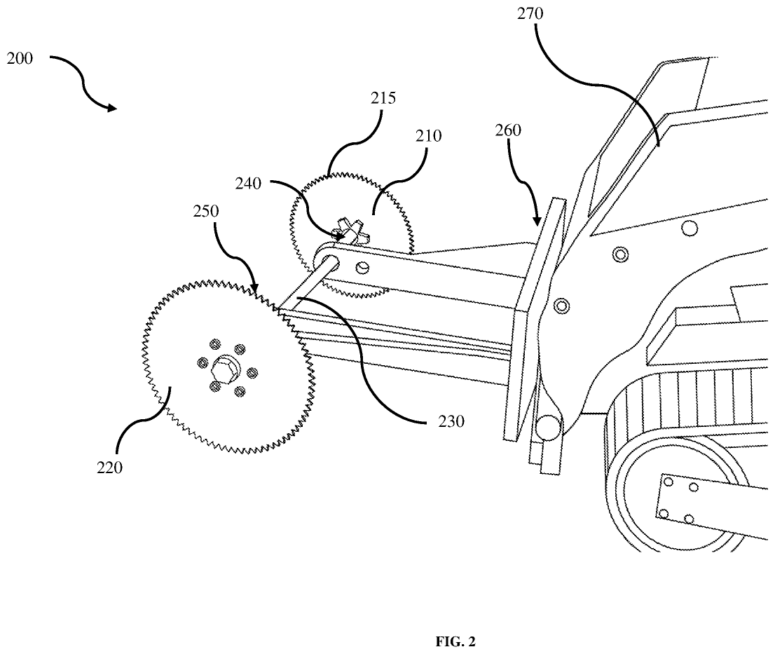

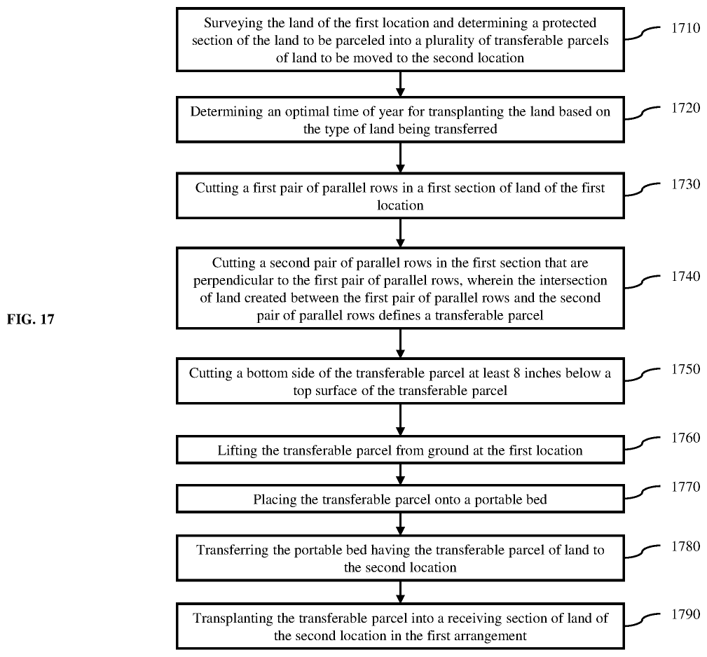

Step 110 consists of cutting, using a first cutting tool 200 (further explained below and illustrated in FIG. 2), a first pair of parallel rows 310, in a first section of land of the first location 330. However, prior to cutting the first section, the land must be surveyed to determine a protected section of the land to be parceled into a plurality of transferable parcels of land to be moved to the second location 1410. Additionally, the method includes surveying the land, as shown and discussed in FIG. 17, and determining an optimal time of the year for transplanting the land based on the type of land being transferred and transplanting during that optimal time. An optimal time may be defined as the best or most efficient time to transplant. In regard to transplanting land, an optimal time may be defined as when the plants are most likely to successfully establish themselves in the new environment. Determining the optimal time requires analyzing a few factors. These factors include the climate in the area, the condition of the soil, the type of plants growing on the land needing to be transplanted, and the organisms present within the land, namely, endangered species. With respect to transferring dolomite prairie, the optimal time of year to transfer the land is during the fall and winter months when the organisms are dormant. This is critical because transferring the land in the winter months has a greater success rate in the transfer of species. Once the land is surveyed, and the optimal time of the year is present, the method proceeds with step 110 by cutting, using a first cutting tool, a first pair of parallel rows, in a first section of land of the first location 330.

A first cutting tool 200 (as shown in FIG. 2) may generally be defined as a tool having a sharp edge intended or adapted for cutting. More specifically, the first cutting tool is defined by having an axel 230, a first blade 210, and a second blade 220. The axel having a first end 240 and a second end 250, the first blade being positioned at the first end of the axel, and a second blade being positioned at the second end of the axel. The first cutting tool may be made and manufactured from a variety of materials and processes. Materials such as carbon steel, stainless steel, aluminum, titanium, etc. may be used during manufacturing of the first cutting tool. Manufacturing processes such as extrusion, molding, casting, welding, shearing, punching, folding, CNC machining, etc. may be used to form the first cutting tool. However, other materials and manufacturing processes may also be used and are within the spirit and the scope of the present invention. The first pair of parallel rows may vary in width depending on the width of the first and second blades of the first cutting tool. The first pair of parallel rows may also vary in length depending on how long of a piece the user intends to cut from the first section of land of the first location 330. The first section of land of the first location may vary in size and shape dependent on how many sections are to be cut, the terrain of the first location, boundaries that the user must work around, wildlife inhabitants, etc.

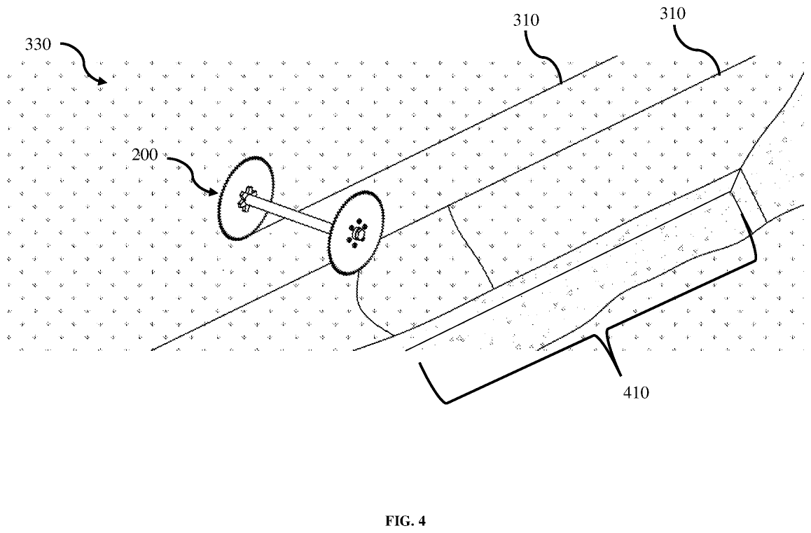

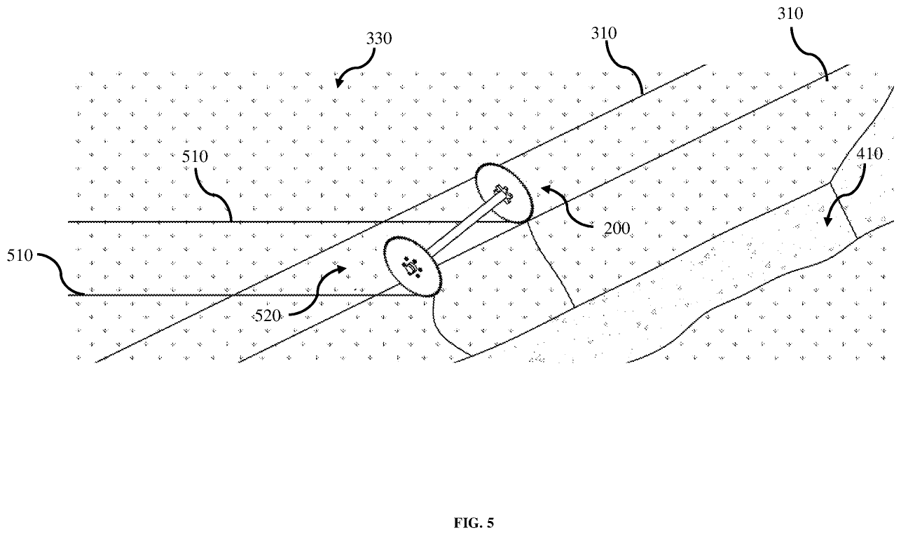

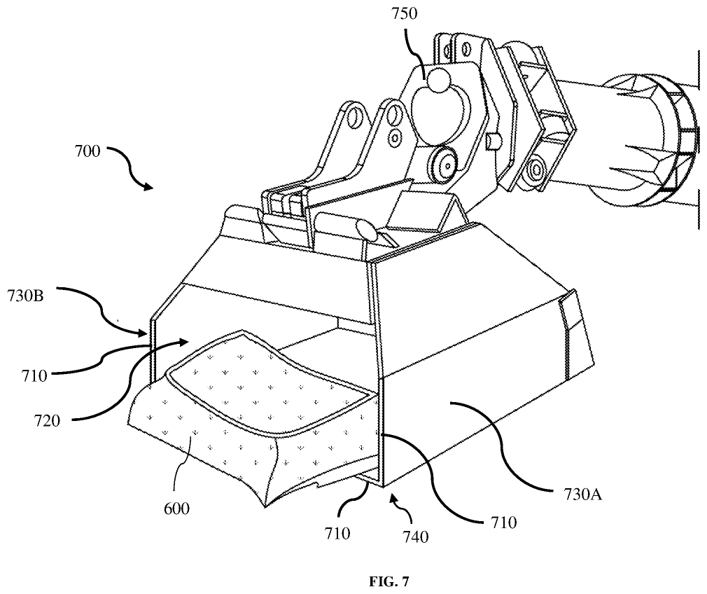

Next, in step 120, the method continues by cutting, using at least one of the first cutting tool 200 and a second cutting tool (700 in FIG. 7), a second pair of parallel rows (510 in FIG. 5) in the first section, that are perpendicular to the first pair of parallel rows 310 (as shown in FIG. 5). However, prior to cutting the second pair of parallel rows, the method may include digging an elongated trench 410 (shown in FIGS. 4, 5, and 6) adjacent to at least one row of the first pair of parallel rows. The criticality of the elongated trench is such that it provides the second cutting tool an initial entry point into the land without harming the transferable parcels.

Referring briefly to FIG. 7, at this point, the land has been cut into rows; however, the rows are still attached to the ground. In a preferred embodiment, at step 120, the second pair or parallel rows are cut using the second cutting tool. The second cutting tool digs under the land and cuts the land perpendicular to the existing rows. The second cutting tool comprises a cutting bottom edge which slices the bottom side of the land thereby detaching it from the Earth. The side edges of the second cutting tool, simultaneously, cut the perpendicular rows, albeit the perpendicular rows are cut one transferable parcel at a time.

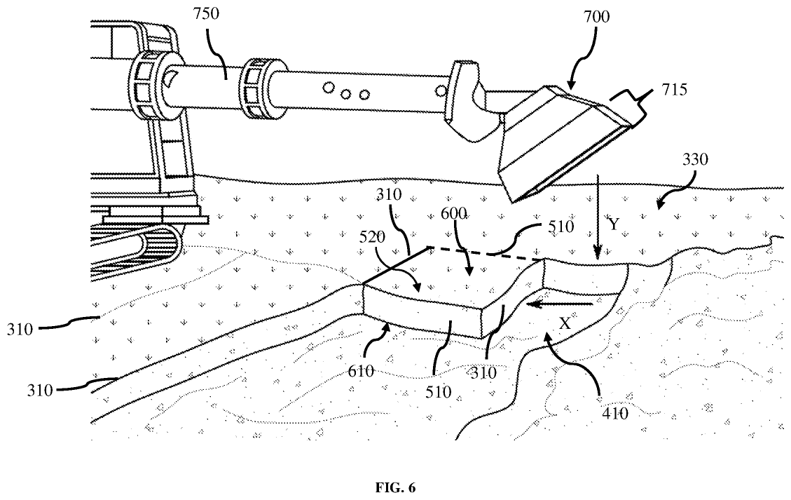

An intersection of land (520 in FIGS. 5 and 6) between the first pair of parallel rows and the second pair of parallel rows, now defines a transferable parcel (further detailed as transferable parcel 900 in FIG. 9). The second cutting tool may be defined as having a cutting edge configured to cut through soil and roots without damaging the transferable parcel. Furthermore, the second cutting tool may include a rectangular container having an open front side, at least two side walls, a bottom panel, and a cutting edge defined by at least one edge of a plurality of edges of the open front side, the at least two side walls, and the bottom panel.

The transferable parcel 900, defined by the intersection of land 520 created between the first pair of parallel rows 310 and the second pair of parallel rows 510, is first examined for at least one of invasive species 910 and endangered species 920.

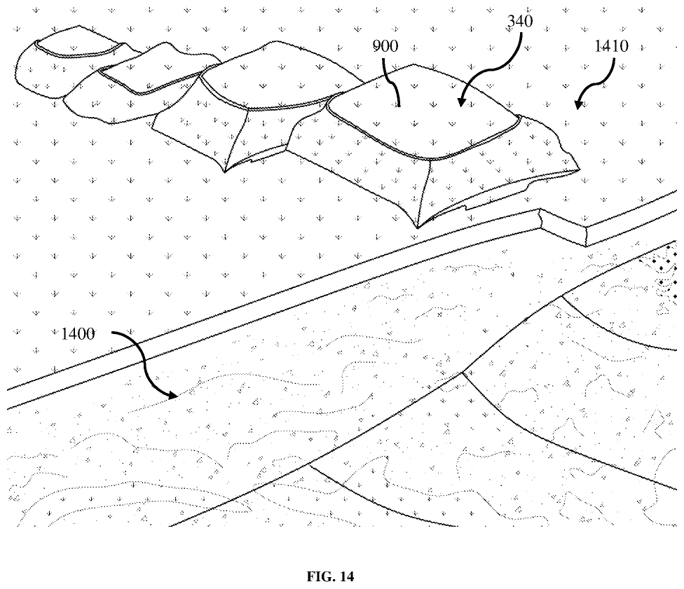

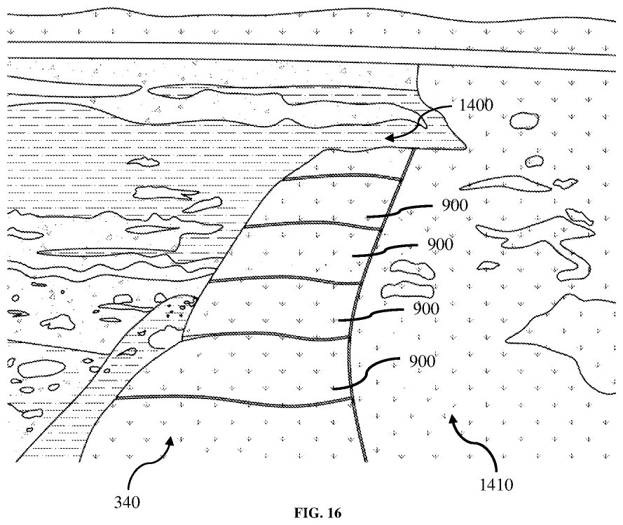

Next, in step 130, the method continues by cutting, using the second cutting tool 600, a bottom side 710 of the transferable parcel 900. The bottom side 710 of the transferable panel may be defined as the outermost piece of land that is desired to be transplanted. This bottom side may be placed directly on the receiving section 1600 of land 320 shown in FIGS. 14 and 16. As mentioned above in step 120, the second cutting tool may have a cutting edge 610 configured to cut through soil and roots without damaging the transferable parcel, as well as a rectangular container configured to carry the transferable parcel. Next, in step 140, the method continues by lifting, using the second cutting tool, the transferable parcel from a ground at the first location 330.

Once the transferable parcel 900 is defined. It may be carefully inspected for invasive and endangered species. If invasive species are discovered, then the method proceeds by removing the invasive species from the transferable parcel before transporting the transferable parcel to the second location remote from the first location, and if endangered species are discovered, then further preserving the endangered species.

Next, in step 150, the method continues by placing the transferable parcel in the first arrangement onto a portable bed. The portable bed 1000 may generally be defined as a portable platform on which goods can be moved. More specifically, the portable bed may be defined as having an at least partially open top section 1010 for allowing the transferable parcel to be exposed to an atmosphere and a bottom platform 1020. In one embodiment, the at least partially open top section may be completely open such that it does not have any obstruction to the ambient atmosphere and/or without a cover or lid which completely or partially encloses the portable bed. In another embodiment, the at least partially open top section has a lid that comprises openings 1015. These openings may be slats or holes that extend through the lid and allow the contents within the bed to have air exposure. Furthermore, the portable bed comprises at least one side that is openable such that the at least one side comprises a side wall open configuration and a side wall closed configuration. The portable bed further comprises a bottom panel that is openable such that the bottom panel comprises a bottom panel open configuration and a bottom panel closed configuration. In further embodiments, the top section may comprise a lid or cover that seals the internal contents from being exposed to the ambient atmosphere; however, said top section would provide an open exposure to a controlled atmosphere within the portable bed. For purposes of this disclosure, the top section of the portable bed is the portion of the bed that is above the bottom panel.

Next, in step 160, the method continues by transferring the portable bed having the transferable parcel of land in the first arrangement to the second location 1410. The transportation of the portable bed includes the use of a vehicle 1300. A vehicle may be defined as a thing used for transporting goods. Examples of vehicles include trucks, forklifts, tractors, four wheelers, quad bikes, etc.

Next, in step 170, the method continues by transplanting the transferable parcel into a receiving section of land of the second location 1410 remote from the first location in the first arrangement 340. Transplanting the transferable parcel includes preparing the second location to define the receiving section, disposing the portable bed proximate to the receiving section, removing the transferable parcel from the portable bed, and placing the transferable parcel in the receiving section. After transplanting the transferable parcel, the method includes maintaining the transferable parcel to promote healthy growth and to preserve the transferable parcel.

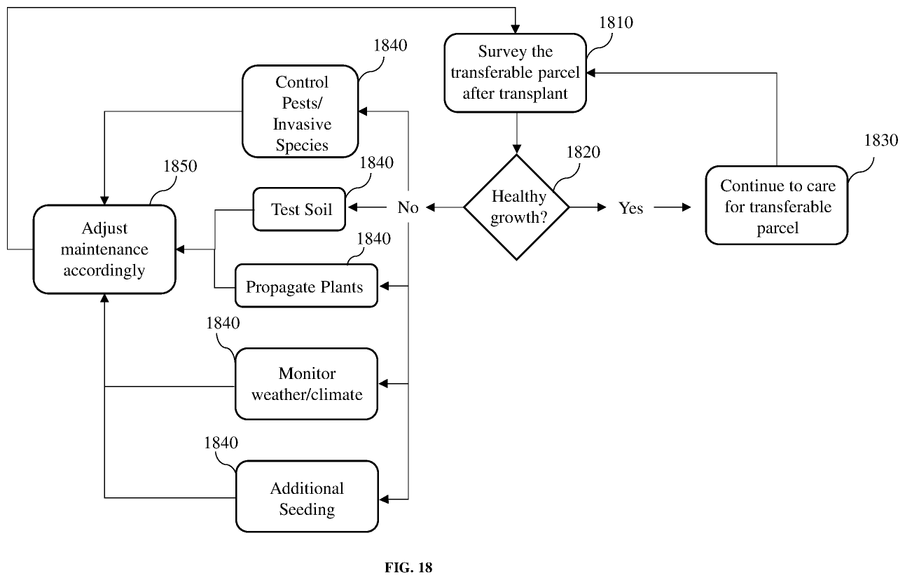

Preparing the second location 1410 remote from the first location may include removing existing soil or land of the same shape and depth of the transferable parcel of land from the first location 330. In one embodiment, preparing the second location may include surveying the land, and examining the second location for invasive species or endangered species, as shown in FIGS. 9 and 18.

Similar to the methods discussed above, invasive species may be removed from the second location 1410 in order to maintain the transferable parcel of land that will take root. In another embodiment, preparing the soil at the second location may include clearing and weeding, tilling, and leveling to define the receiving section before placing the transferable parcel of land in the ground. In other embodiments, the act of preparing the second location remote from the first location to define a receiving section may appear differently in steps or methods. However, other preparation methods are within the spirit and the scope of the present invention. Proximate may be defined as close to or nearby. In one embodiment, removing the transferable parcel from the portable bed may be done through use of a machine such as a forklift. In another embodiment, a person may remove the parcel of land manually depending on the size and weight of the parcel. In another embodiment, the removal may be done through use of a rope and pulley system lowering the parcel into the receiving section.

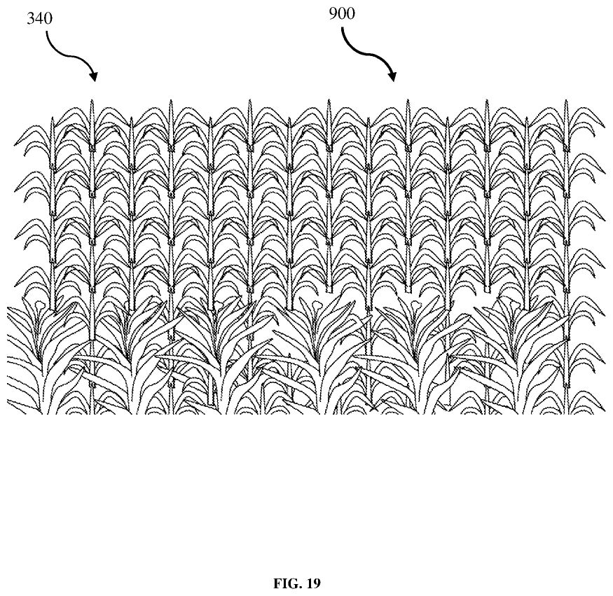

Maintaining the transferable parcel of land to promote healthy growth and to preserve the land is an important piece of this method, as shown in FIGS. 18 and 19. The process of maintaining the land may include surveying the land periodically, propagating certain species of plant, sampling the soil periodically, managing the water distribution, monitoring the land for pests and diseases, weed removal, wildlife management, etc. In some embodiments, promoting healthy growth may require additional attention. For example, in a hot and dry climate, the maintenance needed to preserve the transferable parcel may include creating structures to reduce sun exposure, providing constant moisture to the parcel, adding fertilizer, etc.

Now referring to FIG. 2, FIG. 2 is a perspective view of a first cutting tool 200 having an axel 230, a first blade 210, and a second blade 220, according to an example embodiment. The axel 230 includes a first end 240 and a second end 250 (not shown; behind second blade 220), having the first and second blades attached respectively. The first cutting tool may generally be described as an object used to cut, shape, or remove material. The first cutting tool may take a variety of different forms across different embodiments depending on the use or preference of the user. For example, in the present embodiment, a user may require a first cutting tool 200 to cut one acre of land at a depth of greater than four inches. For dolomite prairie, the depth of the cut may be between 8 to 24 inches. In other embodiments, the depth of the cut may be until bedrock, where the survey reveals that bedrocks lies beneath the surface only a few feet deep.

This particular size of land and required depth will most likely require a large amount of time and effort to cut, therefore may need the first cutting tool to be attached to an automatic or gas-powered machine such as a skid steed loader 270. The cutting tool has an attachment section 260 by which it is secured to the skid steer loader. The attachment section may be configured depending on the type of skid steer loader. As illustrated the cutting tool includes an attaching section defined by a plate configured to be secured to the loader. Additionally, the cutting tool includes two extension arms which may be fixed or vertically adjustable to alter the cutting depth of the cutting tool. In other embodiments where a user needs only to cut a relatively small section of land, such as two meters of land at a depth of five inches, the first cutting tool may include a handle for manual use, rather than an attaching section. This amount of land at the specified depth may only need a cutting tool having a handle to allow the user to manually rotate the axel instead of using heavy equipment. That said, the methods described herein are generally used to move acres of land to preserve said acres of land. As a result, the ideal embodiment is such that the cutting tool includes an attachment section to attach to heavy equipment, including, but not limited to, a skid steer loader. As used herein, heavy equipment refers to large and powerful machines that are primarily used in construction, mining, forestry, agriculture, and other heavy-duty industries. Examples of heavy equipment include bulldozers, excavators, backhoes, cranes, loaders, dump trucks, tractors, and graders, among others. These machines are designed to perform tasks that are too difficult, dangerous, or time-consuming for humans to do manually. Heavy equipment is often characterized by its size, weight, and power, and requires specialized skills and training to operate safely and effectively.

The first blade 210 and the second blade 220 may generally be defined as a circular plate having a sharp edge 215 or cutting surface. In some embodiments, the first and second blades may appear thin and flat made from metal. The cutting edge of a circular blade is the sharp toothed perimeter of the blade that comes into contact with the material being cut, the ground surface. Circular blades typically have multiple teeth arranged in a circular pattern around the blade, with each tooth having a sharp, angled edge that cuts into the material. The shape and orientation of the teeth can vary depending on the specific type of blade and the material being cut. For example, blades designed for cutting wood may have large, widely spaced teeth, while blades for cutting metal may have smaller, more closely spaced teeth with a special coating or material to withstand the heat generated during the cutting process. The cutting edge of a circular saw blade is critical to the quality of the cut and the overall performance of the saw, so it's important to maintain the sharpness and proper alignment of the teeth for optimal cutting results. With regards to cutting into the ground, the cutting edge of the circular blade may vary depending on the type of land being cut. For example, a highly rooted area would require large, widely spaced teeth whereas a sandy area would require smaller, more closely spaced teeth and/or no teeth at all. In other embodiments, the circular blade may include diamond segments. The segments are made of a mixture of diamond particles and metal powders that are bonded together using a process called sintering. Diamond is an extremely hard and durable material that is able to cut through tough materials like concrete and asphalt with ease.

The diamond segments are arranged in a circular pattern around the perimeter of the blade and are separated by slots or gullets that help to remove the material being cut. The segments may have a variety of shapes and sizes, depending on the specific application and the type of material being cut. For example, blades designed for cutting through hard, reinforced concrete may have larger, more widely spaced segments, while blades for cutting through softer materials like asphalt may have smaller, more closely spaced segments.

The cutting edge of a circular saw blade for cutting into the ground is critical to the success of the cutting process. The diamond segments must be properly aligned and securely attached to the blade to prevent them from breaking or coming loose during use. Additionally, the blade must be kept cool during use to prevent overheating and damage to the diamond segments. Proper use and maintenance of the blade, including regular cleaning and sharpening, is essential for optimal cutting performance and longevity.

The axel 230 may generally be defined as a cylindrical rod or shaft. More specifically the axel 230 may be defined as a shaft having a first end 240 and a second end 250 connecting the first blade 210 to the second blade 220. Typically, the axel will rotate allowing the blades to cut into a piece of land. The first and second blades may be attached to the axel using a blade holder or blade adapter. For example, blade holders or adapters may slide onto the axle and be secured with a fastener such as a set screw or bolt, the blade is then mounted onto the holder. In other embodiments, the blades may be secured to the axle using wheel hubs consisting of bearings or bushings to allow for the blades to freely rotate around the axle. Other methods or tools may also be used to secure the blades onto the axle. The first cutting tool may be made from a variety of materials such as carbon steel, stainless steel, aluminum, titanium, composites, etc. and may be manufactured from a variety of different processes. Manufacturing processes may include extrusion, molding, casting, welding, shearing, punching, folding, CNC machining, etc. Other materials and manufacturing processes may also be used and are within the spirit and the scope of the present invention.

Generally, the land is cut at a depth equal to the radius of the first and second blade. However, in other embodiments, the depth of the cut may be controlled such that the depth of the cut into the land is up to the depth of the radius of the blade. With respect to the methods described herein, in certain embodiments, the diameter of the blade is at least 8 inches. Cutting the land at a depth of at least 8 inches allows for the top portion of the land to be preserved, including but not limited to, the surface vegetation and topsoil. It is worth noting that a critical feature of the methods herein is cutting the land to such a depth as to preserve the land. Because land is cut at depths greater than 1-4 inches deep, the land cannot be rolled and must be transported accordingly. Rolling the land into easily transportable sections, as is a general transportation method with sod, damages the bed of the land underneath the surface. This could be detrimental to endangered and/or protected life within the land. The depth of the land cut is unlike the prior art generally relied upon for harvesting or removing sod. In general, sod is typically cut to a depth of about 1 to 2 inches (2.5 to 5 centimeters) using a specialized tool called a sod cutter. This depth is shallow enough to remove the top layer of grass and roots without disturbing the soil underneath, which allows for easy replanting or installation of new landscaping materials. However, in some cases, sod may need to be cut deeper if the underlying soil is heavily compacted or contains rocks or other debris that could interfere with the growth of new plants. In these situations, a deeper cut of up to 4 inches (10 centimeters) may be necessary to ensure that the soil is properly prepared for new landscaping.

The methods herein improve upon the prior art by transporting the underlaying soil. In certain embodiments, because the transferable parcel of land is preserved in the first arrangement, the parcel may be numbered for transplant. Additionally, a second parcel may be cut and removed from underneath the first parcel. Thus, when transplanting the land, the entire protected underbed is preserved as if it was not moved or disrupted. The preservation of the land contributes to the high success rates of the transfer of the land and the preservation and conservation efforts to sustain the life within.

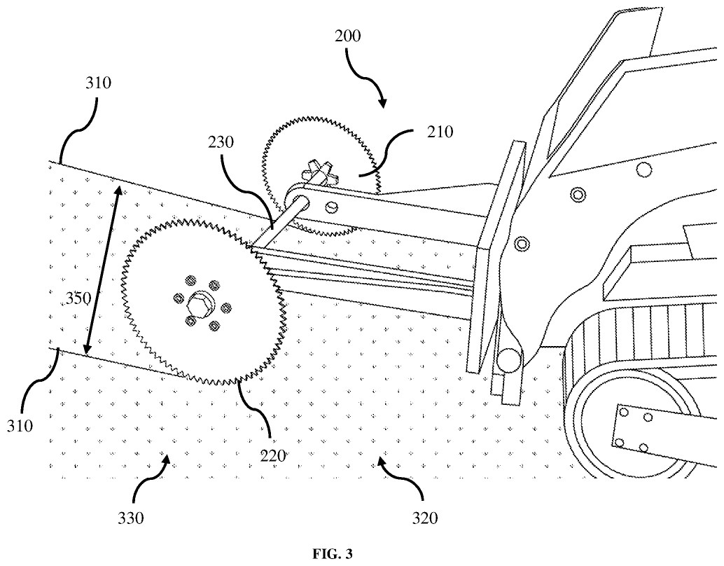

FIG. 3 is a perspective view of the first cutting tool 200 making a first pair of parallel rows 310 in a first section of land 320 of the first location 330, according to an example embodiment. The first pair of parallel rows may vary in length depending on the preference of the user or the required dimensions of the transferable parcel. In the first embodiment, the transferable parcel is four feet wide by four feet long with a height ranging from 8 to 24 inches. The criticality of the dimensions is such that the transferable parcel can (1) preserve the characteristics and quality of the land, and (2) allow the land to be easily transported by the flat bed of a semi-truck. Typically, a flatbed of a semitruck is 8.5 feet wide or 102 inches. As a result, the transferable parcels can rest on the bed of the truck in two rows while maintaining clearance.

The first pair of parallel rows may also vary in width 350 between the rows dependent on the length of the axle and distance between blades. The first section of land 320 may be determined by the user of the first cutting tool, by a law enforcement agency, by the owner of the land, etc. As mentioned above in FIG. 1 the land must first be surveyed to determine a protected section of the land to be parceled before any cuts are made. Generally, a protected section of land may be defined as an area that has been designated to be preserved by a protection effort. A protected section of land may be established to protect or preserve endangered species, unique ecosystems, or natural resources. The first section of land 320 may be chosen because of its inhabitants, plants and animals included, because of its orientation and arrangement, etc. The methods described herein preserve endangered land that may need to be transplanted to protected areas. Some examples of these types of land may include, in particular, dolomite prairies.

Dolomite prairies are a rare and unique type of grassland ecosystem that are found in specific geological areas where the bedrock is made of dolomite, a type of sedimentary rock. Dolomite prairies are characterized by their high biodiversity and unique assemblage of plant and animal species that are adapted to the specific soil and climatic conditions of these ecosystems.

Dolomite prairies are highly threatened by habitat loss and degradation due to human activities such as urbanization, agriculture, and mining. In addition, dolomite prairies are also threatened by invasive species, altered fire regimes, and climate change. As a result, many dolomite prairies have been lost or severely degraded, and those that remain are often highly fragmented.

Transplanting dolomite prairies to protected areas can help to preserve these critical ecosystems and prevent the loss of biodiversity. The process of transplanting dolomite prairies typically involves carefully selecting and collecting soil and plant material from the original site and transporting it to a suitable location that has similar environmental conditions. The transplanted ecosystem can then be carefully monitored and managed to ensure its survival and long-term health.

In other embodiments, the methods herein may be implemented to preserve wetlands, forests, grasslands, and coastal habitats. In general, any type of land that is threatened by human activities or natural disasters and that plays an important ecological role may be a candidate for transplanting to protected areas. The specific type of land and the location of the transplant will depend on the particular needs and priorities of conservation efforts in that area.

Wetlands are areas of land that are saturated with water for at least part of the year. They are home to a diverse range of plant and animal species and play an important role in regulating water flow and filtering pollutants. Wetlands are highly threatened by human activities such as development and agriculture, and many wetland ecosystems have been lost or degraded. Transplanting wetlands to protected areas can help to preserve these critical ecosystems.

Forests are home to a wide range of plant and animal species and provide important ecosystem services such as carbon storage, air and water filtration, and soil conservation. Many forests around the world are threatened by deforestation, climate change, and other human activities. Transplanting endangered forests to protected areas can help to preserve these vital ecosystems and prevent the loss of biodiversity.

Grasslands are areas of land dominated by grasses and other herbaceous plants. They are important habitats for many species of mammals, birds, and insects, and provide important ecosystem services such as carbon storage and soil conservation. Grasslands are threatened by overgrazing, development, and agriculture, and many grassland ecosystems have been lost or degraded. Transplanting endangered grasslands to protected areas can help to preserve these vital ecosystems.

Coastal habitats such as coral reefs, mangrove forests, and salt marshes are important for protecting coastlines from erosion, supporting fisheries, and providing habitat for a wide range of marine and terrestrial species. These habitats are threatened by climate change, pollution, and development. Transplanting endangered coastal habitats to protected areas can help to preserve these critical ecosystems and the species that depend on them.

FIG. 4 is a perspective view of the first location wherein an elongated trench 410 was dug adjacent to at least one row of the first pair of parallel rows 310, according to an example embodiment. In some embodiments, the elongated trench 410 may be defined as a long, narrow depression in the ground that is deeper than the surrounding area. The elongated trench may vary in length and width dependent on the depth of the transferable parcel. The purpose of forming an elongated trench to allow the second cutting tool to easily dig underneath the parcel when it is time to cut the bottom side of the parcel. The trench provides an entry point for the cutting edge of the second cutting tool, shown in FIG. 6. The trench may be dug with an excavator and/or a shovel, for example. Other systems and methods for digging an elongated trench are within the spirit and scope of the present invention.

FIG. 5 is a perspective view of the first cutting tool 200 cutting a second pair of parallel rows 510 that are perpendicular to the first pair of parallel rows 310, according to an example embodiment. It should be noted that cutting the second pair of parallel rows with the first cutting tool is an optional embodiment. The criticality of using the first cutting tool would be to perform the intersection or transferable parcel. The parcel is preformed such that the sides are detached and only the bottom side of the parcel needs to be cut to remove the parcel from the first section. The intersection of land 520 between the first set of parallel rows and the second set of parallel rows defines a transferable parcel of land. The transferable parcel may be referred to in FIG. 7 and further detailed in FIG. 9. The shape of the intersection of land may vary. For example, having the second set of parallel rows perpendicular to the first set of parallel rows creates the shape of the intersection to be rectangular, however in other embodiments, the shape may resemble a parallelogram. The size may also vary dependent on the desired parcel size or equipment available, etc.

Referring to FIG. 6 and FIG. 7, the formation of the transferable parcel in the first arrangement 600 is shown. FIG. 6 is another embodiment for cutting the second pair of parallel rows. The second pair of parallel rows is cut using the second cutting tool 700. Specifically, the second pair of parallel rows 510 is cut simultaneous to the bottom side 610 of the transferable parcel as to define the transferable parcel 520 that is detached from the first section 330.

FIG. 7 is a perspective view of a second cutting tool 700 having a cutting edge 710 and a rectangular container 715, according to an example embodiment. The cutting edge 710 is configured to cut through soil and roots without damaging the transferable parcel. The rectangular container having at least one open front side 720, at least two side walls 730A and 730B, and a bottom panel 740. The cutting edge 610 may be defined by at least one edge of a plurality of edges of the open front side 620. This may include at least one of the front side edges adjoined to the bottom panel and/or the at least two side walls. The edge adjoined to the bottom panel is configured to cut through the bottom side of the first section of land to detach the bottom side of the land from the Earth to define the transferable parcel. The cutting edges on the front side adjoined to the side walls are configured to cut the second pair of parallel rows. The second cutting tool may be configured to be in attachment with another tool or machine, such as heavy equipment 750.

The cutting edge 710 may be made from a hard, durable material, such as steel. The angle of the cutting edge may vary dependent on the terrain of a particular piece of land and may include serrated teeth in certain embodiments consistent with this disclosure. Regular maintenance such as sharpening and honing may be necessary to maintain the cutting edge on the second cutting tool 700.

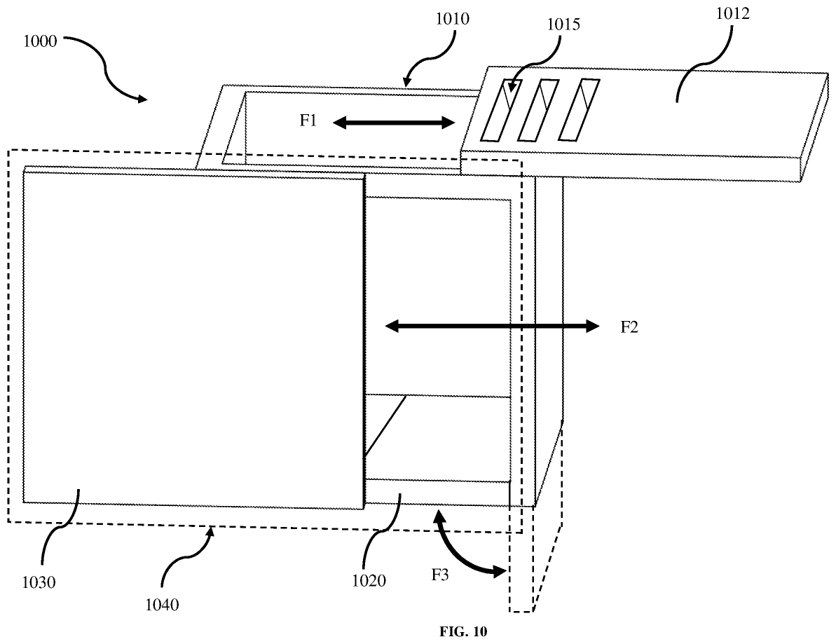

The rectangular container, having an open front side 720 allows the transferable parcel to be cut, then received by the container and held until ready to be placed on a portable bed (1000 in FIG. 10) for transport. Because the cutting edge on the at least two side walls 630 cuts the land to define the transferable parcel, the side walls may be spaced apart to fit the exact parcel. Thus, if the transferable parcel is four feet wide by four feet wide, then the distance between the side walls is four feet and the dimensions of the rectangular container or bucket is also four feet by four feet. In other embodiments, such as those where the second parallel rows are cut using the first cutting tool, the distance between the side walls may be greater than the width of the transferable parcel to allow for clearance with the machinery as to not damage the parcel of land. In certain embodiments, the second cutting tool may have an open back side. The open back side may allow the first section of land, i.e., each formed transferable parcel, to slide through the backside of the container so that the second cutting tool can keep cutting the land to define a plurality of parcels. The second cutting tool may them circle back to teach parcel to lift it to the transport area and/or bed. The bottom panel and the side walls support the transferable parcel in such transport, as specifically shown in FIG. 7. Alternatively, in other embodiments, if the transferable parcels are freely detached and in the first arrangement, then one may move the transferable parcels using a lift, such as a forklift or other heavy equipment. Using the second cutting tool to cut the second parallel rows, the bottom edge, and lift the parcel to the transport bed, is the most efficient means of defining the transferable parcel and preserving it in the first arrangement. The transferable parcel may then slide out one of the open ends into or onto the bed for transport. This is better understood in view of FIG. 6 as discussed below.

Now, referring back to FIG. 6, FIG. 6 is a perspective view of the second cutting tool 700 cutting a bottom side 610 of an intersection of land 520 without damaging the transferable parcel, according to an example embodiment. In this embodiment, the motion of the second cutting tool is shown by arrows Y and Z. The second cutting tool first lowers itself in direction Y such that the open front side 720 is adjacent to a side of the intersection of land. Once the open front side of the cutting tool is near the side of the intersection of land, the second cutting tool will proceed in direction X cutting the bottom side 710 of the intersection of land. As the cutting tool cuts the bottom side of the intersection of land, the intersection of land will be forced into the rectangular container.

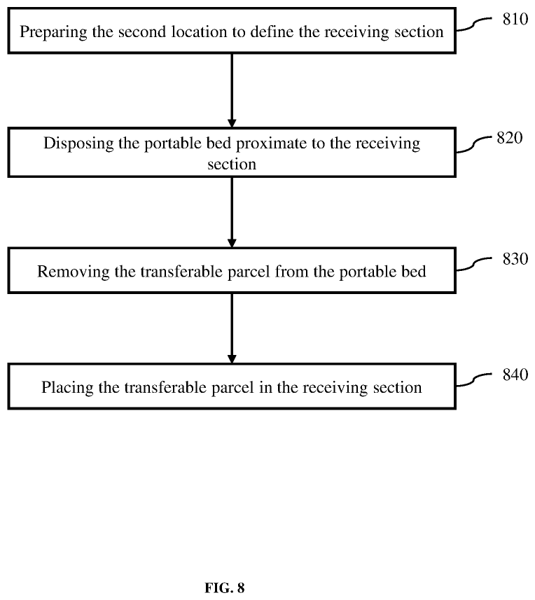

FIG. 8 is a flowchart illustrating a method for transplanting a transferable parcel of land at a second location 1410 remote from the first location, as mentioned in step 170 in FIG. 1, according to an example embodiment. First, transplanting the transferable parcel begins with step 810, preparing the second location to define a receiving section. In one embodiment, preparation may include digging the depth of the parcel and tilling the land. In another embodiment, preparing the second location may include fencing off an area, fertilizing the soil, taking soil samples, and watering the soil. The receiving section may be created using a variety of different methods, and tools. The land at the receiving section is removed to a depth equivalent to at least the depth of the transferable parcel. The area of land removed at the receiving section is equivalent to the area of all of the transferable parcels. For example, if one acre equivalent of transferable parcels is moved, then the receiving section of the land at the second location should be devoid of one acre of land.

Next, in step 820, the portable bed having the second section of the land is disposed proximate to the receiving section. Proximate may be defined as near or close to. The portable bed may be placed on the ground next to the receiving section, on a platform or table close to the receiving section, and/or hung above the receiving section using heavy machinery. In one embodiment, the portable bed containing the transferable parcel of land may need to be examined for quality concerns, or because of transportation issues that may have affected the parcel, before placing the parcel into the receiving section. Next, in step 830, the transferable parcel is removed from the portable bed. The transferable parcel may be removed from the bed by use of machines such as forklifts or excavators. In one embodiment, the bed is lifted over the receiving section using heavy machinery and the transferable parcel is released from or removed from the bed by sliding the transferable parcel off the bed through one of the open and/or openable sides and/or by dropping the bed through the openable bottom side of the bed. The transferable parcels are placed next to each other until the entire receiving section is filled. Other tools or methods may also be used to remove the parcel from the bed. Lastly, in step 840, the transferable parcel is placed into the receiving section. FIG. 16 illustrates the transferable parcels placed into the receiving section of the land at the second location. As illustrated, the transferable parcels are transplanted and maintained in the first arrangement to preserve the land.

FIG. 9 is an isometric view of a transferable parcel 900, according to an example embodiment. The transferable parcel 900 may be rectangular and may have a depth between eight and twenty four inches. In the present embodiment, we can see the shape and depth 930 of the parcel. In other embodiments, the transferable parcel may take different shapes and depths depending on how the cuts are made. The transferable parcel may contain invasive species 910 such as the spotted knapweed. The transferable parcel may also contain endangered species 920 such as the grasshopper sparrow. The first arrangement of the transferable parcel may include the specific layering of soil beneath the surface, the structure of habitats within the parcel, the root pathways throughout the soil, etc. This arrangement is to be preserved when in transport and throughout transplantation. The transferable parcel may appear differently across different terrains in different locations. For example, transferable parcels in dry terrains may include drought resistant vegetation and rocky soil; whereas, transferable parcels in wetland or forests may include hydric soil, saturated substrate, and high vegetation.

As shown, the dimensions of the transferable parcel are denoted by length L, width W, and height H. The length and width of the transferable parcel are at least 2 feet. More specifically, the length and width of the transferable parcel is at least 4 feet. The height H or depth of the soil is greater than a shallow cutting, greater than 4 inches in depth. In other embodiments, the height of the transferable parcel is at least eight inches in height. To properly transfer the transferable parcel in a manner such that it preserves the arrangement of the parcel and protects the matter within, the depth of the soil may include numerous layers of soil. Soil is a complex mixture of organic and inorganic materials that forms the foundation of life on Earth. The layers of soil can be broadly classified into four main types: the O horizon 950, A horizon 960, B horizon 970, and C horizon 980. The O horizon is the uppermost layer of soil and is composed of organic material such as leaves, twigs, and decaying plant matter. This layer is commonly referred to as the litter layer and is vital for supporting plant growth and providing nutrients for microorganisms. The A horizon, also known as the topsoil, is the layer immediately below the O horizon and is rich in organic matter, minerals, and nutrients. It is the layer where most plant roots grow and is crucial for sustaining agricultural crops. The B horizon, also known as the subsoil, is the layer beneath the A horizon and is composed of minerals and clays that have leached from the topsoil. This layer can be several feet thick and is typically harder and more compact than the topsoil. The C horizon, also known as the parent material, is the deepest layer of soil and is composed of weathered rocks and minerals that have not yet been transformed into soil. This layer is the foundation upon which the other layers of soil form. In addition to these four main layers, soils can also contain other layers such as the R horizon, which is the bedrock layer, and the E horizon, which is a layer of leached minerals that can occur between the A and B horizons in some soils. In summary, the layers of soil are the O horizon, A horizon, B horizon, and C horizon, each with its unique properties and functions in supporting plant growth and sustaining life on Earth. Understanding the different layers of soil and their characteristics is essential for soil management and agricultural practices. In one embodiment, the transferable parcel includes at least soil horizon layers O and A. In another embodiment, the transferable parcel includes at least soil horizon layers O, A, and B. In another embodiment, the transferable parcel includes at least soil horizon layers O, A, B, and C. The criticality in ensuring that the transferable parcel includes said soil horizon layers is that the land is maintained in the same arrangement. Additionally, by maintaining the land in the first arrangement, the transplant is more likely to sustain growth of the land at the second location such that the material, namely, endangered species, can prosper.

Before the transferable parcel is placed into the receiving section of the land, transferable parcel must be inspected for endangered and/or invasive species. When a section of protected land is being transplanted with native plant species, it is important to remove any invasive species that may be present in order to prevent them from outcompeting the transplanted species and degrading the ecosystem. The specific method used to remove invasive species will depend on the particular species and the severity of the infestation. Some possible methods for removing invasive species from a section of protected land include mechanical removal, chemical control, biological control, and/or a combination of methods thereof.

Mechanical removal involves physically removing the invasive species from the land. This can be done using hand tools, such as shovels or hoes, or heavy equipment, such as bulldozers or excavators, depending on the size of the infestation and the terrain of the land. Chemical control involves using herbicides or other chemicals to kill the invasive species. This method must be used carefully and with proper safety precautions to avoid harming native plants and wildlife. Biological control involves introducing natural predators or diseases that specifically target the invasive species. This method must be used carefully and with proper research to ensure that the introduced species do not harm native plants and wildlife. In some cases, a combination of mechanical, chemical, and biological control methods may be used to effectively remove invasive species from the land. Once the invasive species have been removed, it is important to monitor the land carefully to ensure that they do not return. This may involve regular inspections, ongoing maintenance, and continued efforts to promote the growth and success of the transplanted native species.

Further preserving the endangered species may include marking where the habitat was discovered, protecting its habitat, monitoring the population, covering the habitat with a form of barrier during transport, etc. The transferable parcel may be between 8 to 24 inches in depth and may be rectangular if both pairs of parallel cuts are perpendicular to one another. When a section of land is being transplanted with native species and endangered species are present, it may be necessary to take samples of these species for cloning and replanting in order to preserve their genetic diversity and ensure their long-term survival. This process is known as ex situ conservation, and it involves removing endangered species from their natural habitat and maintaining them in a controlled environment, such as a greenhouse or seed bank, until they can be replanted in a suitable habitat.

The specific steps involved in the process of taking samples for cloning and replanting will depend on the particular species and the availability of resources and expertise. Some possible steps in the process may include species identification, collection of plant and animal material, propagation and cloning, and replating. The first step in the process is to identify the endangered species that are present in the section of land that is being transplanted. This may involve surveys, field observations, and genetic testing to determine the specific species and their genetic diversity. Once the endangered species have been identified, plant material such as seeds, cuttings, or tissue samples may be collected from the plants for cloning and replanting. This process must be done carefully to ensure that the plant material is healthy and representative of the genetic diversity of the species. The collected plant material may be propagated using a variety of methods, such as tissue culture or cloning, in order to produce multiple copies of the plant. This process can take several months or even years, depending on the species and the specific method used. Once the plant material has been propagated and cloned, the new plants can be replanted in a suitable habitat. This may involve carefully selecting a site with the appropriate environmental conditions, preparing the soil and other site conditions, and planting the new plants in a way that promotes their survival and growth.

It's important to note that the process of taking samples for cloning and replanting endangered species should be done carefully and with the guidance of wildlife experts and conservation organizations. The process can be complex and expensive, but it is essential for preserving the genetic diversity of endangered species and ensuring their long-term survival and increasing the success rate of preserving the transferable parcel in the first arrangement for conservation and preservation of the land.

The methods for inspecting and examining the land for invasive and endangered species may happen at any time prior to transplant at the second location. For example, the first section of land at the first location may be inspected, prior to cutting the first pair of parallel rows, for endangered species. Samples of said species may be taken, such as seeds and/or cuttings, for cloning and replanting, to maintain and restabilize the populations of the endangered species. It is understood that these processes may occur before transplanting at the second location to prep for the replant process to maintain the endangered land after transplant. Additionally, it will advance the protection of the land by identifying species that need to be removed (invasive) and species that need to be protected. Invasive species would be removed from each transferable parcel so as to not infect the second location of land and jeopardize the protection of the land in the first arrangement.

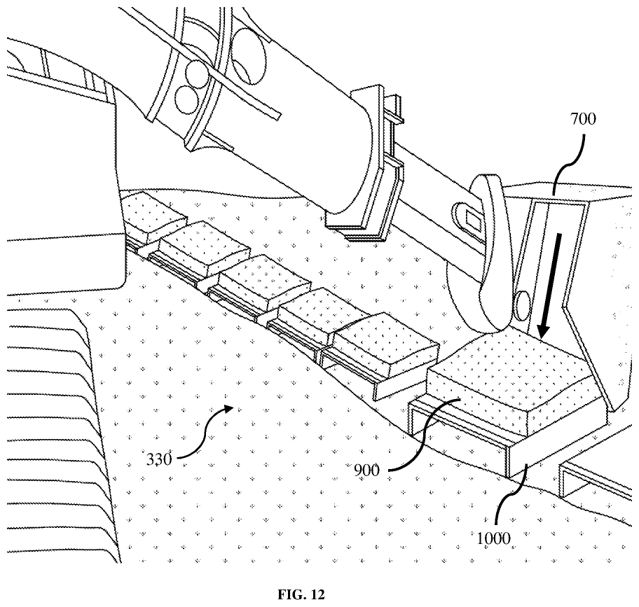

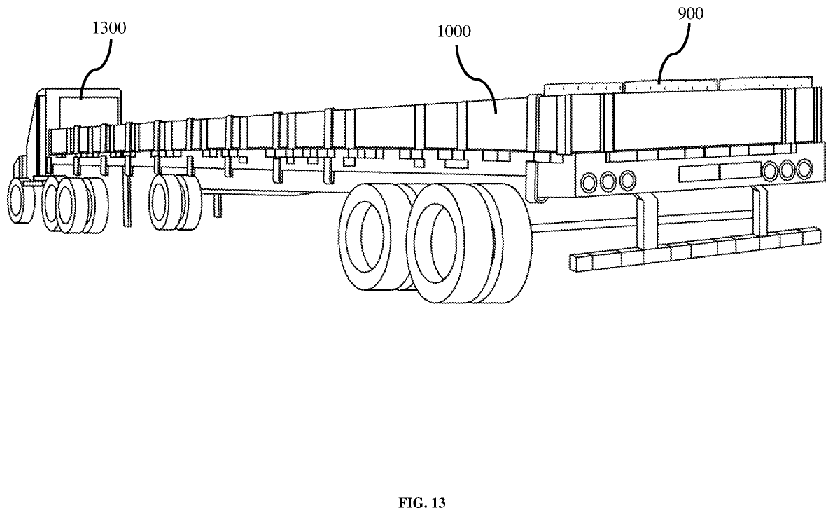

FIG. 10 is an isometric view of a portable bed 1000 having an at least partially open top section 1010 and a bottom platform 1020, according to an example embodiment. The portable bed 1000 includes an at least partially open top section 1010 for allowing the transferable parcel to be exposed to an atmosphere. The portable bed further includes at least one side 1030 that is openable such that the at least one side includes a side wall open configuration 1040 and a side wall closed configuration, denoted by sliding the side wall 1030 sliding in direction F2 and top side wall 1012 slidable in direction F1. Said openable side wall may be lockable. In certain embodiments, openable side wall 1030 includes the bottom side. The side wall open configuration allows the transferable parcel to be received by the portable bed through a slidably attached wall. The side wall closed configuration may be used when in transport for protection against unwanted pests or objects. The portable bed includes a bottom panel that is openable such that the bottom panel includes a bottom panel open configuration and a bottom panel closed configuration, as shown by directional F3 illustrating the bottom panel hingedly opening to release the transferable parcel through the bottom of the bed. The advantage of having an openable bottom panel is such that the type of land being the transferable parcel is unstable as to be able to be slid. For example, marsh-like land with high water content in the soil would be better preserved in the first arrangement by dropping the parcel into the receiving section of land through the bottom panel. The bottom panel open configuration allows the parcel to be dropped from the bottom platform and into a receiving section of land. The bottom panel closed configuration allows the parcel to be protected from outside factors such as pests, of sharp objects. In order to maintain the transferable parcel in a first arrangement, the transferable parcel needs to be at least partially exposed to the atmosphere if not fully exposed to the atmosphere. In other embodiments, the bed may be a pallet, for example. A pallet, as shown in FIG. 12 may have a bottom panel, an open top side, and no side walls. The side walls may be removably attachable, as shown in FIG. 13 showing the beds loaded onto a flat-bed truck for transportation.

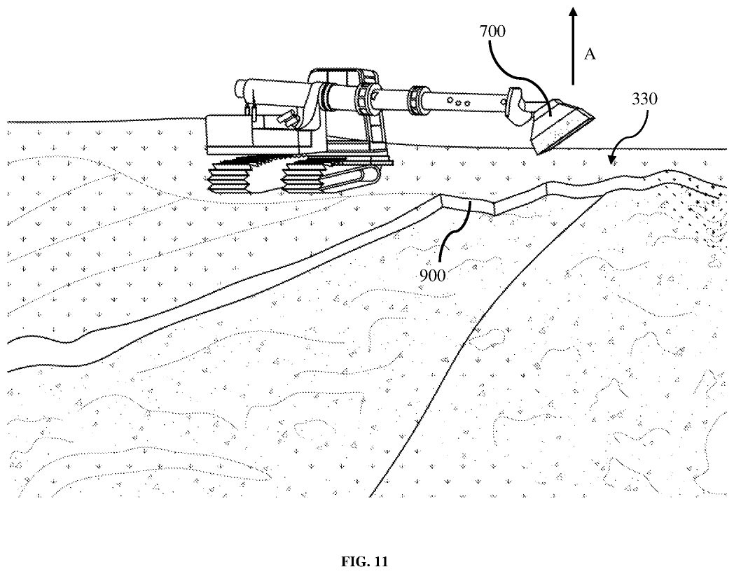

FIG. 11 through FIG. 16 further describe the methods of preparing the transferable parcel and transplanting it at the second location while maintaining it in the first arrangement. FIG. 11 is a perspective view of the second cutting tool 700 lifting a transferable parcel 900 from the ground, according to an example embodiment. Cutting of the transferable parcel, as shown in FIG. 6, involves sliding the cutting edge beneath the ground surface while receiving the parcel inside the rectangular container without damaging the transferable parcel. Lifting the transferable parcel may include raising the rectangular container upwards in direction A such that the cutting edge of the cutting tool does not interfere with any other intersections of land. In some embodiments, the cutting tool may be operated manually. For example, the cutting tool may be attached to a pulley system where an operator may lower the cutting tool, then manually force the cutting tool through the earth cutting the bottom side of the intersection of land. Once the intersection of land remains within the rectangular container, the operator may engage the pulley system raising the tool upwards in direction A. Once the parcel is lifted, a separate machine may transport the parcel from the cutting tool to a portable bed.

FIG. 12 is a perspective view of the second cutting tool 600 placing the transferable parcel 900 onto a portable bed 1000, according to an example embodiment. The second cutting tool allows the transferable parcel to leave the front opening by tilting the rectangular container in such a way that the bottom panel is at an angle, relative to the ground, of between twenty degrees and ninety degrees. In other embodiments, the bottom panel may be removed, allowing the transferable parcel to fall downwards onto the portable bed 1000. In other embodiments, the cutting tool bottom panel may contain a mechanical element acting as a conveyor belt allowing the bottom panel to remain level at zero degrees while the transferable parcel is conveyed onto the portable bed.

FIG. 13 is a perspective view of several portable beds being transported, according to an example embodiment. The number of portable beds containing transferable parcels being transported may depend on a variety of factors. Factors may include the size of the vehicle 1300 transporting the portable bed, the desired number of transferable parcels, the shape and size of the transferable parcels and portable beds. As referred to in step 160, in FIG. 1, the vehicle may be in the form of a variety of different shapes and sizes. For example, if transporting the parcel across a city to be transplanted into a park, the vehicle may be in the form of a flat-bed semi-truck. If the parcel is to be transplanted in a section of land located proximate, such as a few meters, from the first location 330, the vehicle may be in the form of a four-wheeler or tractor. If the second location 1410 is in a different state needing a large quantity of parcels, then the vehicle used to transport the portable bed having the transferable parcel will likely be a semi-truck. Other vehicles may also be used and are within the spirit and the scope of the present invention.

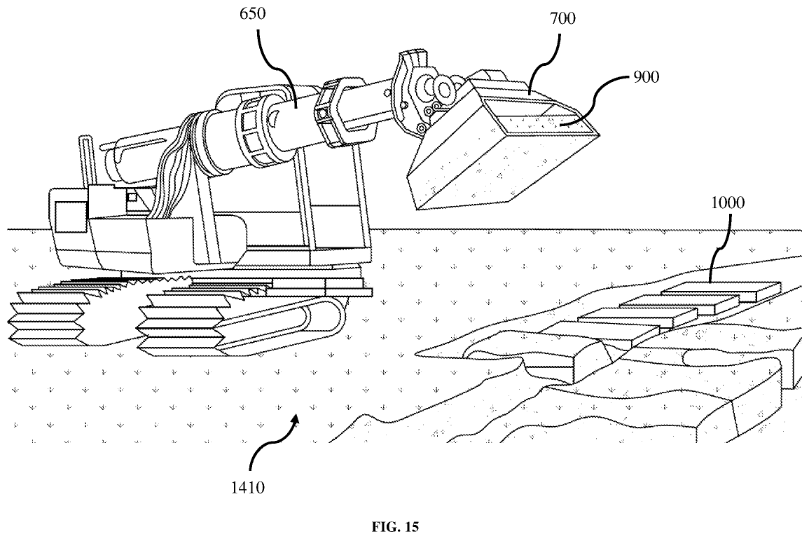

FIG. 14 is a perspective view of the portable bed 1000 being disposed near a receiving section of land 1400 at the second location 1410, according to an example embodiment. FIG. 15 is an illustration of the second cutting tool 700 removing the transferable parcel 900 from the portable bed 1000, according to an example embodiment. Removing the transferable parcel from the portable bed includes orienting the second cutting tool near the portable bed such that the open front side is ready to receive the transferable parcel. Once the parcel is lined up with the opening, the second cutting tool should move towards the parcel, having the cutting-edge wedge in between the portable bed and the parcel. In some embodiments, the portable bed may have removable side walls. Removable side walls may allow one wall to be removed providing access to the parcel while bracing the parcel as the cutting edge wedges the bottom panel underneath the bottom side of the transferable parcel. Once the transferable parcel is positioned on the bottom panel of the second cutting tool, the second cutting tool will begin moving away from the portable bed and toward the receiving section of land located at the second location 1410. This constitutes one example embodiment of placing the transferable parcel of land into the receiving section. A second embodiment may include sliding the transferable parcel directly off of the bed into the receiving section. The bed may be lifted using a crane or excavator over the receiving section and maneuvered such that the land slides into the receiving section. A third embodiment may include leaving the plurality of beds within the receiving section such that the plurality of beds is made of an organic, decomposable material. A fourth embodiment may include opening the bottom panel of the bed, whether slidable or hingedly openable and lifting the bed upwards as to leave the transferable parcel in the first arrangement in the receiving section of the second location. Other embodiments of placing the land within the receiving section while maintaining the integrity and quality of the transferable parcel are within the spirit and scope of the disclosure.

FIG. 16 is a perspective view of a plurality of transferable parcels 900 in the receiving section 1400, according to an example embodiment. The receiving section 1400 may be cleared, weeded, and dug out in preparation for the transplant of the transferable parcel. As mentioned above in FIG. 1, step 170, preparing the second location 1410 may include removing existing soil or land of the same shape and depth of the transferable parcel of land from the first location 330. In one embodiment, preparing the location may include surveying the land, and examining the second location for invasive species or endangered species. In another embodiment, preparing the soil at the second location may include clearing and weeding, tilling, and leveling to define the receiving section before placing the transferable parcel of land in the ground.

FIG. 17 is a flowchart illustrating a method for transferring land from a first location 330 in a first arrangement 340 to a second location 1410 remote from the first location in the first arrangement, according to a second example embodiment. This method begins with step 1710. Step 1710 begins by surveying the land of the first location and determining a protected section of the land to be parceled into a plurality of transferable parcels of land to be moved to the second location 1410. Surveying the land may include visually observing an area of land, conducting tests to determine the quality of the soil of water on the land, measuring the land, researching the prior history of the land, analyzing any legal constraints relating to land, etc. Other methods of surveying may also be used and are within the spirit and the scope of the present invention. Determining a protected section of the land includes gathering all data and research relating to the land in question, analyzing the information, and choosing the best land for the desired use/or reason for transplant. Once the land is surveyed at the first location 330 and a protected section of that land is determined, the method will continue to step 1720.

Next, in step 1720, the method proceeds with determining an optimal time of year for transplanting the land based on the type of land being transferred. As mentioned above, in FIG. 1, an optimal time may be defined as when the plants are most likely to successfully establish themselves in the new environment. This time may vary depending on the type of plant living in the parcel, the environment of the first location compared to the environment of the second location, what kind of maintenance/when maintenance may be available to the transplanted parcel, etc. The optimal time may be any time of the year. Once the optimal time has been determined, the method will continue to step 1730.

Next, in step 1730, the method proceeds with cutting a first pair of parallel rows in the first section of land of the first location 330. As mentioned above in FIG. 1, the first pair of parallel rows may vary in size and shape depending on the parcel of land needing to be cut or the preference of the landowner. Cutting may be defined as the process of excavating or digging into the ground to create a depression or hole. Other methods of cutting may also be used and are within the spirit and the scope of the present invention. Once the first pair of parallel rows are cut in the first section of land in the first location 330, the method will continue to step 1740.

Next, in step 1740, the method proceeds with cutting a second pair of parallel rows in the first section that are perpendicular to the first pair of parallel rows, where the intersection of land created between the two sets of rows define a transferable parcel. As shown above in the example embodiment of FIG. 9, the parcel of land may appear to be rectangular if parallel cuts are perpendicular to one another. In other embodiments, the intersection may resemble a different shape depending on how accurate the cuts are made and the preference of the user. For example, a landscaper may want a parcel in the shape of a circle. In which case, the method step of cutting land may require a different cutting tool better tasked with cutting arcs rather than parallel lines. Once the parcel of land has been created, the method continues to step 1750.

Next, in step 1750, the method continues by cutting the bottom side of the transferable parcel at least eight inches below a top surface of the transferable parcel, defining a parcel depth 930. This cutting may be performed by use of tools such as excavators, backhoes, shovels, sod cutters, garden spade, etc. In some embodiments, such as FIG. 9, the parcel depth 930 may be eight inches deep measured from the stop surface of the transferable parcel. In other embodiments, the depth may need to be greater. For example, a person may desire a specific piece of land having a plant with lengthened roots 940 such as trees. This example of a transferable parcel will require a depth greater than eight inches in order to cut the land without damaging the roots. After the bottom side of the transferable parcel has been cut, the method continues to step 1760.

Next, in step 1760, the method continues by lifting the transferable parcel from ground at the first location 330. The transferable parcel may be lifted with tools or machines such as digging tools, forklifts, pulley systems, pallet jacks, telescopic handlers, loaders, excavators, etc. Once the parcel has been lifted, the method continues to step 1770. Step 1770 includes placing the transferable parcel onto a portable bed. The portable bed may include a partially open top section, for allowing the transferable parcel to be exposed to an atmosphere, and a bottom platform. The portable bed may further include at least one side that is openable such that the at least one side includes a side wall open configuration and a side wall closed configuration. The bottom panel may also be openable such that the bottom panel has a bottom panel open configuration and a bottom panel closed configuration. The need for an open configuration is necessary to promote growth and to provide a positive nutrient rich environment for the transferable parcels to remain in while being transported. Once the transferable parcel is placed onto the portable bed, the method proceeds to step 1780.

Next in step 1780, the method includes transferring the portable bed having the transferable parcel of land to the second location 1410. As mentioned above, transferring the portable bed may utilize a vehicle 1300 such as a truck or semi, or may utilize something smaller such as a tractor or forklift. The transfer depends on a plurality of factors such as the distance at which the land must travel to reach a second location remote from the first location, the vehicles available, the size and shape of the parcels, the preference of the operator, the weather during transfer days, etc. Once the transferable parcel has been transferred to the second location, the method proceeds to step 1890.

Next in step 1790, the method continues with transplanting the transferable parcel into a receiving section of land of the second location 1410 remote from the first location in a first arrangement 340. As mentioned above in FIG. 1, transplanting the transferable parcel includes preparing the second location to define the receiving section, disposing the portable bed proximate to the receiving section, removing the transferable parcel from the portable bed, and placing the transferable parcel in the receiving section. After transplanting the transferable parcel, the method includes maintaining the transferable parcel to promote healthy growth and to preserve the transferable parcel. There are several different ways to maintain a parcel of land. Below FIG. 18 gives an example method for maintaining a parcel to promote healthy growth.

FIG. 18 is a flowchart illustrating a method of maintaining a transferable parcel to promote healthy growth and to preserve the transferable parcel, according to an example embodiment. This method begins with step 1810, surveying the transferable parcel once transplantation is complete. Surveying includes using several senses to observe the parcel. This may include touching the parcel to feel dryness or abnormal texture, visually observing the color or consistency of the parcel, etc. Once observations are made, the observations are analyzed and concluded to determine if the parcel is showing healthy growth, as shown in decision diamond 1820. If the observations conclude that the parcel is experiencing healthy growth, then the method proceeds to step 1830. Step 1830 is to continue monitoring and caring for the transferable parcel. If the observations conclude that the parcel is not experiencing healthy growth, then the method continues to a plurality of options 1840. These options are possible solutions to promote healthy growth. The plurality of options includes examples of common solutions to help unhealthy land. Examples include monitoring weather conditions or climate, the need for additional seeding, pest control or weed control, propagation, soil testing, etc. Once a solution is chosen, the method proceeds to step 1850. Step 1850 includes adjusting maintenance according to the solution chosen. Once the action is taken, the method continues back to step 1810, and the cycle continues.

FIG. 19 is a front perspective view of healthy growth of a transferable parcel 900 in a first arrangement 340, according to an example embodiment. After the plurality of transferable parcels were transplanted into the second location, the method may further include maintaining the land. When land has been transplanted to a second location, it requires specific processes to maintain its health and ensure the success of the transplant. Transplanted land requires careful watering to maintain the right amount of moisture. Overwatering can lead to root rot, while underwatering can cause stress and hinder plant growth. The soil should be kept moist but not waterlogged. The soil in the transplanted land may be deficient in nutrients, so it may require fertilizing. Adding organic matter such as compost can help improve the soil structure and provide necessary nutrients for plant growth. Pruning can help promote healthy growth and prevent overcrowding. Transplanted plants may require pruning to remove dead or damaged branches, and to promote new growth. Mulching is a useful technique for maintaining moisture levels in the soil and suppressing weed growth. A layer of mulch can also help regulate the temperature of the soil. Transplanted land may be vulnerable to pests and diseases, so it is important to monitor for any signs of infestation or infection. Regular inspection can help identify problems before they become severe, and appropriate treatment can be administered. With respect to protected lands having endangered species, habitat restoration efforts, captive breeding and crop seeding and replanting are all but a few conservation efforts to ensure that the land is preserved. Endangered species often face habitat loss or degradation, so restoring and protecting their habitat is crucial for their survival. This process may involve removing invasive species, re-introducing native plants, and creating suitable nesting or breeding sites. The methods herein specifically improve over the prior art by minimizing habitat loss and degradation by preserving the land in the first arrangement as transported from the first location to the second location.

Additionally, captive breeding programs can help supplement wild populations and increase the chances of survival for endangered species. This process involves breeding individuals in captivity and then releasing them into the wild to increase genetic diversity and ensure that the species can continue to reproduce.

Overall, it is essential to monitor the growth of transplanted plants regularly. Any stunted or slow growth should be investigated to determine the cause and corrective action taken. If the plants are not growing as expected, it may indicate a lack of nutrients, water, or other environmental factors that need to be addressed. Regular monitoring of endangered species populations can help identify threats and measure the success of conservation efforts. This process may involve conducting population surveys, tracking movements, and monitoring behavior.

In summary, maintaining transplanted land requires careful attention to watering, fertilizing, pruning, mulching, pest and disease control, and monitoring growth. By taking these steps, the transplanted land can thrive and provide a healthy environment for plant growth.

Healthy growth refers to the process of sustained and balanced development of plants and other living organisms within an area. Typically, a parcel of land experiences healthy growth by having balanced nutrient levels meaning the soil contains adequate amounts of nutrients such as nitrogen, phosphorus, and potassium, as well as other micronutrients. Furthermore, a parcel of land may promote healthy growth by having proper irrigation, appropriate light exposure, minimal pest and disease pressure, proper soil structure and drainage, biodiversity, etc. Overall, healthy growth of the transferable parcel will result in strong and vigorous plants with high yields, resistance to environmental stresses, and a reduced need for external supplements such as fertilizers or pesticides.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A method for transferring land from a first location in a first arrangement to a second location in the first arrangement, the method comprising:
cutting, using a first cutting tool, a first pair of parallel rows, in a first section of land of the first location;
cutting, using at least one of the first cutting tool and a second cutting tool, a second pair of parallel rows, in the first section, that are perpendicular to the first pair of parallel rows, wherein an intersection of land between the first pair of parallel rows and the second pair of parallel rows defines a transferable parcel;
cutting, using the second cutting tool, a bottom side of the transferable parcel of land;
lifting, using the second cutting tool, the transferable parcel from a ground at the first location;
placing the transferable parcel onto a portable bed;
transferring the portable bed having the transferable parcel of land to the second location; and
transplanting the transferable parcel into a receiving section of land of the second location in the first arrangement.

2. The method of claim 1, wherein the first cutting tool comprises:
an axel having a first end and second end;
a first blade at the first end of the axel; and
a second blade at the second end of the axel.

3. The method of claim 2, wherein the second cutting tool comprises:
a cutting edge configured to cut through soil and roots without damaging the transferable parcel.

4. The method of claim 1, wherein the second cutting tool further comprises:
a rectangular container having an open front side, at least two side walls, and bottom panel; and
the cutting edge defined by at least one edge of a plurality of edges of the open front side, the at least two side walls, and the bottom panel.

5. The method of claim 1, wherein the portable bed comprises:
an at least partially open top section for allowing the transferable parcel to be exposed to an atmosphere; and
a bottom platform.

6. The method of claim 5, wherein the portable bed further comprises at least one side that is openable such that the at least one side is comprises a side wall open configuration and a side wall closed configuration.

7. The method of claim 5, wherein the portable bed further comprises a bottom panel that is openable such that the bottom panel comprises a bottom panel open configuration and a bottom panel closed configuration.

8. The method of claim 1, wherein transferring the portable bed to the second location comprises using a vehicle.

9. The method of claim 1, wherein transplanting the transferable parcel of land further comprises:
preparing the second location to define the receiving section;
disposing the portable bed proximate to the receiving section;
removing the transferable parcel from the portable bed; and
placing the transferable parcel in the receiving section.

10. The method of claim 1, wherein, after transplanting the transferable parcel, maintaining the transferable parcel to promote healthy growth and preserve the transferable parcel.

11. The method of claim 1, wherein prior to transferring the transferable parcel to the second location, the method comprises examining the transferable parcel for at least one of invasive species and endangered species such that if invasive species are discovered, then removing the invasive species from the transferable parcel before transporting the transferable parcel to the second location, and if endangered species are discovered, then further preserving the endangered species.

12. The method of claim 1 further comprising, prior to cutting the first section, determining an optimal time of year for transplanting the land based on the type of land being transferred and transplanting the land during the optimal time of the year.

13. The method of claim 1, wherein the transferable parcel is between 8 to 24 inches in depth and is rectangular.

14. The method of claim 1 further comprising, prior to cutting the second pair of parallel rows, digging an elongated trench adjacent to at least one row of the first pair of parallel rows.

15. The method of claim 1 further comprising, prior to cutting the first section, surveying the land of the first location and determining a protected section of the land to define the first section of land to be parceled into a plurality of transferable parcels of land to be moved to the second location.

16. A method for transferring land from a first location in a first arrangement to a second location in the first arrangement, the method comprising:
surveying the land of the first location and determining a protected section of the land to be parceled into a plurality of transferable parcels of land to be moved to the second location;
determining an optimal time of year for transplanting the land based on the type of land being transferred;
cutting a first pair of parallel rows in a first section of land of the first location;
cutting a second pair of parallel rows in the first section that are perpendicular to the first pair of parallel rows, wherein the intersection of land created between the first pair of parallel rows and the second pair of parallel rows defines a transferable parcel;
cutting a bottom side of the transferable parcel at least 8 inches below a top surface of the transferable parcel;
lifting the transferable parcel from ground at the first location;
placing the transferable parcel onto a portable bed;
transferring the portable bed having the transferable parcel of land to the second location; and
transplanting the transferable parcel into a receiving section of land of the second location in the first arrangement.

17. The method of claim 16, wherein transplanting the land further comprises:
preparing the second location to define the receiving section;
removing the transferable parcel from the portable bed;
placing the transferable parcel in the receiving section; and
maintaining the transferable parcel of land within the second location.

18. The method of claim 17 further comprising, prior to transferring the transferable parcel to the second location, examining the transferable parcel for at least one of invasive species and endangered species.

19. The method of claim 18 wherein if invasive species are discovered, then removing the invasive species from the transferable parcel, and wherein if endangered species are discovered, then further preserving the endangered species.

20. A system for moving land from a first location in a first arrangement to a second location in same first arrangement, the system comprising:
a first cutting tool comprising:
i. an axel having a first end and second end;
ii. a first blade at the first end of the axel; and
iii. a second blade at the second end of the axel;
a second cutting tool comprising:
i. a rectangular container having an open front side, at least two side walls, and bottom panel;
ii. a cutting edge defined by at least one edge of a plurality of edges of the open front side, the at least two side walls, and the bottom panel; and
a portable bed for receiving a transferable parcel cut using the first cutting tool and the second cutting tool, the bed comprising an at least partially open top section for allowing the transferable parcel to be exposed to an atmosphere and a bottom platform.
